(19) United States
(12) Patent Application Publication
(10) Pub. No.: US 2024/0291179 A1
(43) Pub. Date: Aug. 29, 2024

(54) BATTERY CONNECTOR ASSEMBLY

(71) Applicant: ILLINOIS TOOL WORKS INC., Glenview, IL (US)

(72) Inventor: Eric LEVERGER, Epone (FR)

(21) Appl. No.: 18/568,688

(22) PCT Filed: Jun. 16, 2022
(86) PCT No.: PCT/US2022/033715

§ 371 Date: Dec. 8, 2023

(30) Foreign Application Priority Data
Jun. 16, 2021 (EP) 21179709.7
Jul. 5, 2021 (EP) 21183692.9
Jul. 7, 2021 (EP) 21184237.2

(51) Int. Cl. H01R 11/09; B60L 50/64; H01M 50/209; H01M 50/503; H01M 50/517; H01R 4/50

(52) U.S. Cl. CPC H01R 11/09; B60L 50/64; H01M 50/209; H01M 50/503; H01M 50/517; H01R 4/5008; H01R 4/5066; H01M 2220/20; H01R 2201/26

(57) ABSTRACT

A battery connector assembly for mechanically and electrically coupling two or more batteries, includes: at least two interface members, each interface member configured to connect to respective terminals of two adjacent batteries; an electrical contact member, configured to operably attach to the at least two interface members so as to provide an electrically conductive conduit between the two adjacent batteries; and a connector housing, with a slot adapted to retainingly receive and cooperate with the electrical contact member.

The invention relates generally to a battery connector assembly. In particular, the invention relates to a battery connector assembly for mechanically and electrically coupling two or more batteries.

### BACKGROUND

Electrical energy can be stored using batteries, which convert chemical energy into electrical energy. Lithium ion batteries are used in rechargeable battery systems. Conventional battery modules for connecting lithium batteries are well known and widely used as power sources for mobile electronic devices such as cameras, smart phones and laptop computers.

FIG. 1 shows an example battery module described in U.S. Pat. No. 20,193,72082A1. The battery module 1 includes a pair of batteries 3 connected together. Each battery 3 has a positive electrode terminal and a negative electrode terminal facing directions different from each other and arranged in close contact. A pair of positive temperature coefficient (PTC) thermistors 5 are provided respectively to the positive and negative electrode terminals, on one side of the pair of batteries 3. A connection member 7 electrically connects the positive electrode terminal and the negative electrode terminal on the other side of the pair of batteries 3. In addition, a connector 9 is provided in which four wires are connected to a single connection terminal 11 to electrically connect the batteries 3 to an external system. The batteries 3 are electrically coupled to one another by the connection member 7 and fixed to place relative to one another by insulating members 13.

As the demand for greater power outputs for electronic devices increases, battery modules and systems have increased in volume. This is especially the case in the electric vehicle sector, where large battery capacities are required to boost the vehicle range.

FIG. 2 shows a battery pack system 51 for an electric vehicle, including five lithium ion batteries 53 arranged within a case 65. The batteries 53 are connected to one another in series via busbars 57. An electric connector 59 is provided to supply electric power stored in the battery pack 1 to an electric vehicle. The size and configuration of the battery system depends on the vehicle space available, as well as, the power required. The battery pack system shown in FIG. 2 is large and designed to produce a predetermine output power to a vehicle. In order to modify the arrangement of the battery system, the casing, as well as, the configuration of the batteries, would need to be rearranged. Therefore, there is a need to provide a system having an improved modularity. In particular, there is a need to provide lightweight solution of connecting batteries together without needing to redesign the entire battery system.

It would be desirable to provide a battery connector assembly. Particularly, it is an object of the invention to provide a battery connector assembly that is lightweight. It is another object of the present invention to provide a battery connector assembly that can mechanically and electrically couple two or more batteries in a modular way.

The present invention provides at least an alternative to battery connector assemblies of the prior art.

### SUMMARY OF THE INVENTION

In accordance with the present invention there is provided a battery connector assembly according to the appended claims.

According to an aspect of the present invention, there is provided a battery connector assembly for mechanically and electrically coupling two or more batteries. The battery connector assembly comprises at least two interface members, each interface member configured to connect to respective terminals of two adjacent batteries; an electrical contact member, configured to operably attach to said at least two interface members so as to provide an electrically conductive conduit between the two adjacent batteries; and a connector housing, comprising a slot adapted to retainingly receive and cooperate with said electrical contact member.

Thus, the battery connector assembly electrically couples multiple batteries in a modular way. In particular, different configurations and arrays of batteries can be setup in an efficient way without needing to redesign the entire system. This allows different power outputs of battery systems to be achieved by connecting multiple batteries together, without adding significant weight to the system.

Advantageously, in some embodiments, at least a portion of the electrical contact member is adapted to biasingly engage with the at least two interface members of the two adjacent batteries.

In some embodiments, the electrical contact member comprises an upper contact plate and an opposing lower contact plate.

Advantageously, in some embodiments, the electrical contact member comprises a fold conjoining the upper contact plate and the lower contact plate so as to form a resiliently biased U-shaped clip. This is particularly advantageous because the fold acts as a stop to locate the received interface members in a predetermined position. In addition, the upper contact plate and the lower contact plate are made integral with one another.

Advantageously, said electrical contact member further comprises at least one retainer member configured to operably engage with said housing so as to retain said electrical contact member within said housing.

Advantageously, in some embodiments, the battery connector further comprises a cam lever lock mechanism operably coupled with the connector housing and adapted to contactingly lockingly engage with the electrical contact member. The cam lever lock mechanism applies pressure onto the electrical contact member to improve the coupling between the electrical contact member and the interface members.

In some specific embodiments, the cam lever lock mechanism comprises a latch mechanism adapted to lockingly engage with a recess of the connector housing. By having a latch mechanism that is adapted to lockingly engage a recess of the connector housing, the electrical contact member is held in position in engagement with the interface members. When the latch mechanism engages the recess in this way, pressure is maintained onto the electrical contact member to improve the coupling engagement between the electrical contact member and the interface members.

Advantageously, in some embodiments, the electrical contact member is made of an electrically conductive material.

Advantageously, in some embodiments, the connector housing is made of an electrically insulating material.

According to another aspect of the present invention, there is provided an electric vehicle battery array, comprising a plurality of electric vehicle batteries operably connected by at least a battery connector assembly.

### BRIEF DESCRIPTION OF THE DRAWINGS

Embodiments of the invention are now described, by way of example only, hereinafter with reference to the accompanying drawings, in which:

FIG. 1 illustrates an exploded view of a known battery module;

FIG. 2 illustrates a schematic view of a known battery pack system;

FIGS. 3A-3F illustrate a first example of a battery connector in a: (3A) perspective top view; (3B) top view; (3C) front view; (3D) bottom view; (3E) perspective bottom view; and (3F) exploded view;

FIGS. 4A-4C illustrate a perspective view of: (4A) an electrical connection bracket; (4B) two connection brackets with mounts; and (4C) two connection brackets each mounted onto a battery plate;

FIGS. 5A-5B illustrate a perspective view of a battery connector assembly including the first example battery connector and two connection brackets: (5A) before assembly; and (5B) after assembly;

FIGS. 6A-6H illustrate a second example of a battery connector in a: (6A) perspective top view; (6B) top view; (6C) front view; (6D) side view; (6E) bottom view; (6F) bottom perspective front view; (6G) bottom perspective back view; and (6H) exploded view;

FIGS. 7A-7B illustrate a perspective view of a battery connector assembly including the second example battery connector and two connection brackets: (7A) before assembly; and (7B) after assembly;

FIGS. 8A-8H illustrate a third example of a battery connector in a: (8A) perspective top view; (8B) top view; (8C) side view; (8D) bottom view; (8E) front view; (8F) bottom perspective back view; (8G) bottom perspective front view; and (8H) exploded view;

FIGS. 9A-9D illustrate a perspective view of a battery connector assembly including the third example battery connector and two connection brackets: (9A) before assembly;

(9B) after assembly in an unlocked position; (9C) after assembly in an unlocked position showing the direction of motion of the lever; and (9D) after assembly in a locked position;

FIGS. 10A-10H illustrate a fourth example of a battery connector in a: (10A) perspective top view; (10B) top view; (10C) side view; (10D) bottom view; (10E) front view; (10F) bottom perspective back view; (10G) bottom perspective front view; and (10H) exploded view; and

FIGS. 11A-11E illustrate a perspective view of a battery connector assembly including the fourth example battery connector and two connection brackets: (11A) before assembly; (11B) after assembly in an unlocked position; (11C) after assembly in a locked position showing the direction of motion of the lever; (11D) showing a close-up view from the rear and (11E) showing a close-up view from the front.

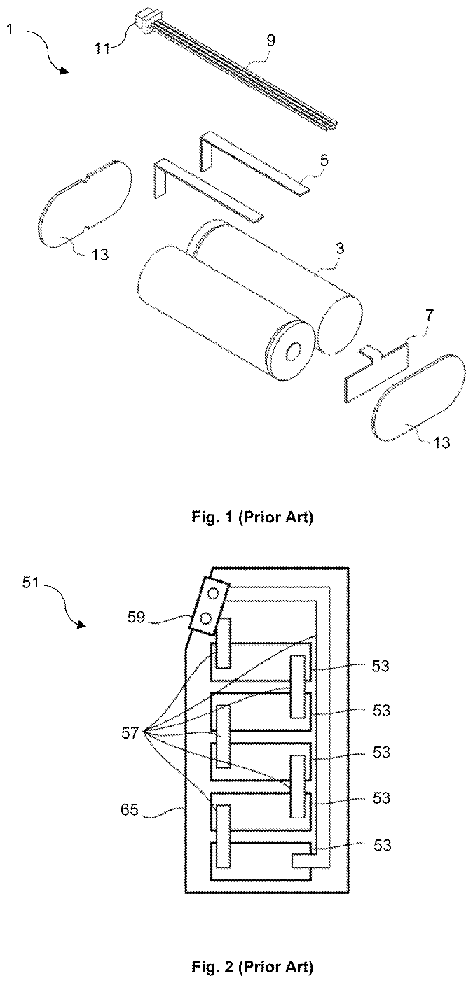

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

Like reference numerals are used to depict like features throughout.

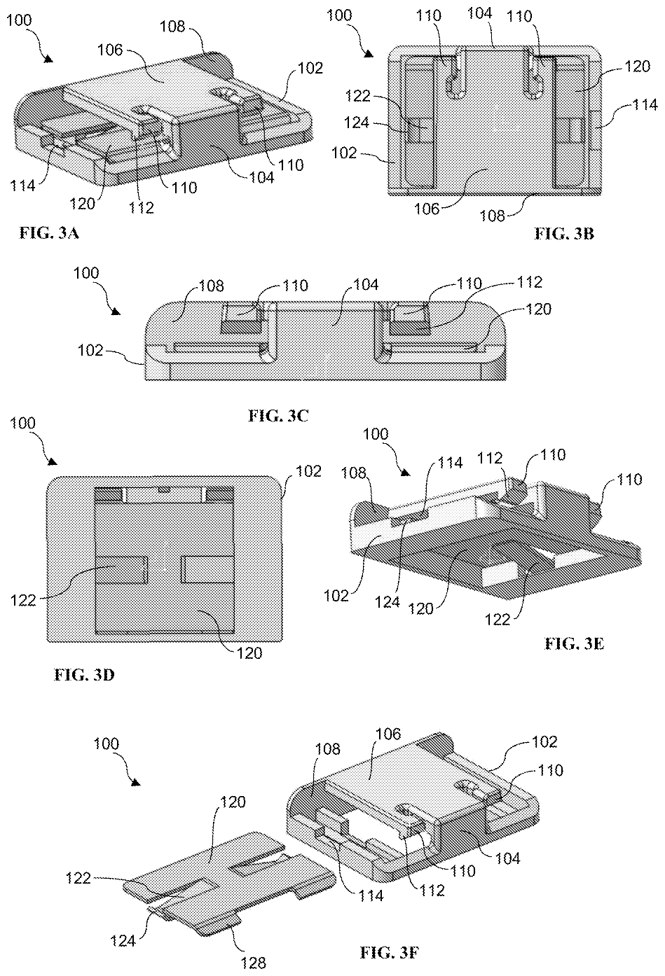

Referring now to FIGS. 3A-3F, there is shown a battery connector 100 including a housing 102 and a contact plate 120. The housing 102 of the battery connector 100 has a side wall and an integral rear face 108. A top face 106 extends away from the rear face 108, and a front face 104 interconnects the top face 106 and a front part of the side wall. At a front end of the top face 106, a protruding pin 110 is provided at each lateral side, each of which terminate at a hook 112 projecting downwards. The shape of the housing 102 together forms a slot in which the contact plate 120 is held in place. In this example embodiment, the housing 102 is made of an electrically insulating material, and the contact plate 120 is made of an electrically conductive material.

As best shown in FIG. 3F, the contact plate 120 is substantially planar, except it is additionally provided with opposing legs 122 projecting downwards from the body of the contact plate 120. Each leg 122 terminates with a foot 124 extending upwards. A front edge of the contact plate 120 is provided with two lips 128, one on each side. The lips 128 are spaced apart by a distance corresponding to the width of the front face 104 of the housing 102, such that the lips 128 protrude out of the slot of the housing 102 when the contact plate 120 is held within the housing 102. The contact plate 120 is insertable into the housing 102 from the side to be held within the housing 102. When the contact plate 120 is held within the housing 102, the foot 124 of the contact plate 120 is held within a cavity 114 of the housing 102.

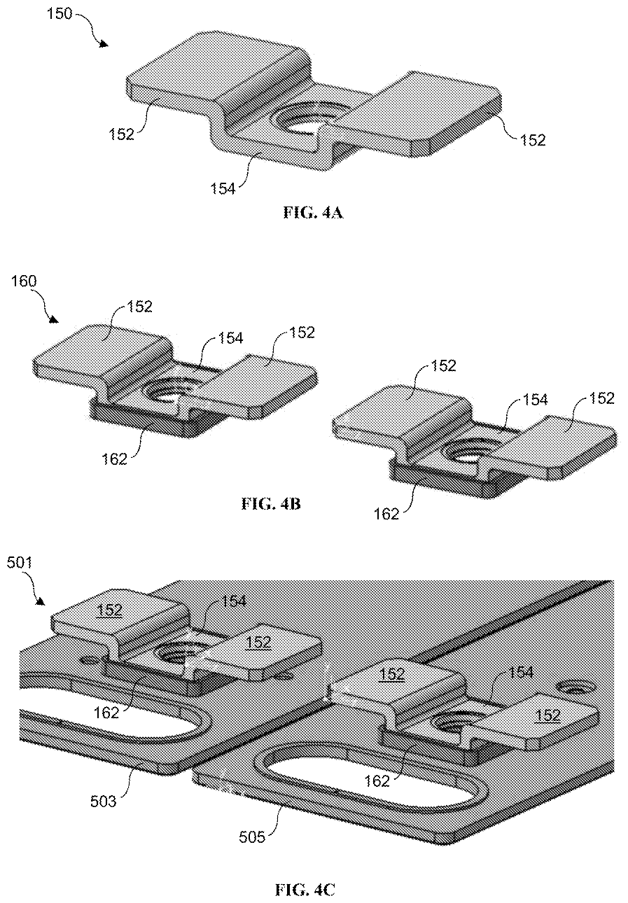

FIGS. 4A-4C shows an electrical connection bracket 150 having a base 154 and two wings 152, each wing 152 integrally formed with the base 154. A coupling 162 is provided to the base 154 to form a bracket assembly 160, to attach the bracket 150 to a first terminal 503. FIG. 4C shows two brackets 150 each attached to a separate terminals 503,505. The brackets 150 act as an interface between the batteries and the battery connector 100. The terminals 503,505 may be provided via a substantially planar busbar.

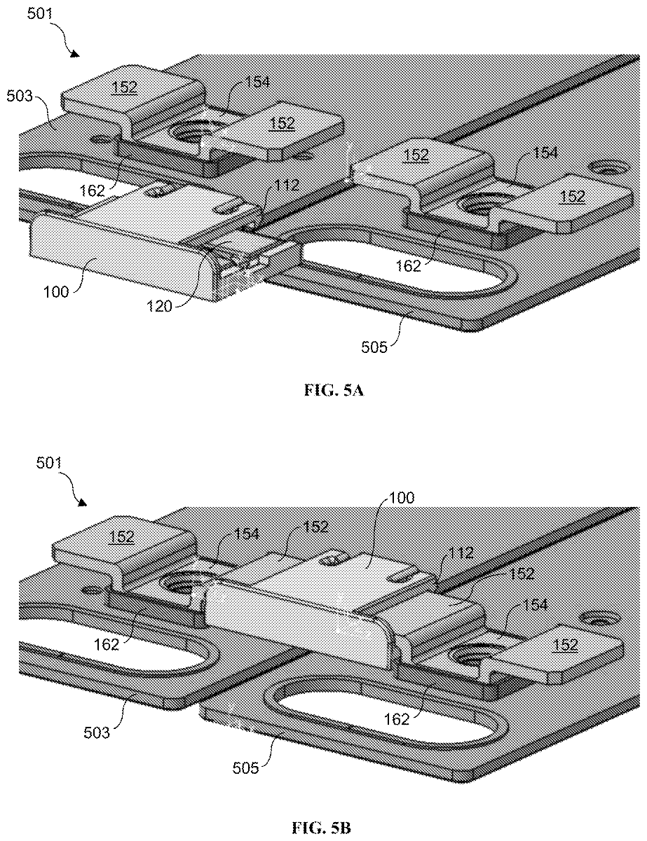

FIGS. 4A-4C and 5A-5B illustrate the full assembly of the battery connector assembly 501, including the attachment of the two electrical connection brackets 150 (i.e. interface) to the battery terminals (see FIGS. 4A-4C), and the attachment of the battery connector 100 onto the connection brackets 150 (see FIGS. 3A-3F). In order to connect the two terminals 503,505, and therefore the batteries, the battery connector 100 is positioned such that the contact plate 120 engages with each of the connection brackets 150. In this example embodiment, the lips 128 of the contact plate 120 engage with the connection brackets 150. By engaging the contact plate 120 with the connection brackets 150, an electrical connection is provided between the connection brackets 150 and therefore also between the batteries. The battery holder 100 is held in a predetermined position using the hook 112 and the rear face 108 of the housing 102. In particular, the side face of the inner wings 152 engage with the rear face 108 of the contact plate 120. In addition, the hook 112 clips onto the opposing side face of the inner wings 152, holding the battery connector 100 in place. Thus, the contact plate 120 acts as an electrically conductive conduit (i.e. pathway) between the batteries. In this example embodiment the battery connector 100 is used to connect adjacent electric vehicle batteries.

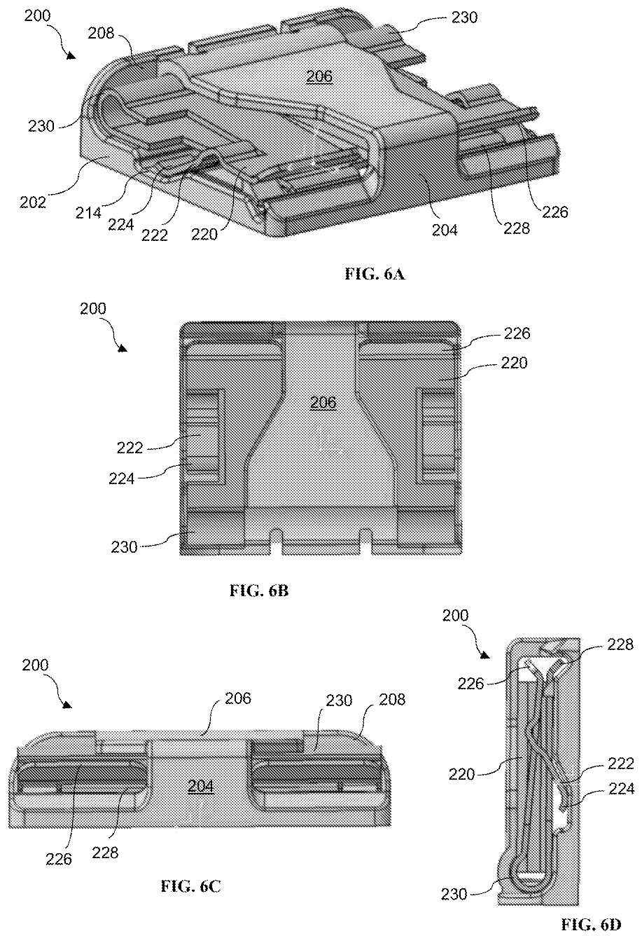

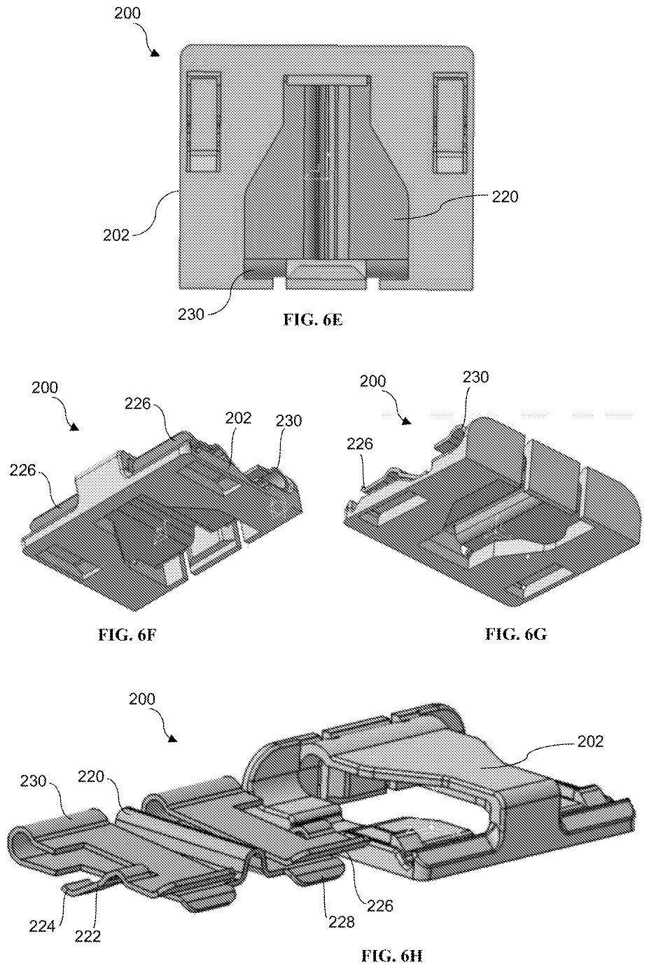

Referring now to FIGS. 6A-6H, there is provided another example embodiment of a battery connector 200. The battery connector 200 is similar to that in FIG. 1, but the top face 206 of housing 202 is not provided with the protruding pins and hooks. Instead, the top face 206 of the housing 202 converges towards the front face 104. In addition, the contact plate 220 is modified from the contact plate 120, in that the contact plate 220 of the battery connector 200 includes an upper plate and an opposing lower plate, which are conjoined at one end by a fold 230. The upper plate and the opposing lower plate together form a U-shaped clip. A front edge of the upper and lower plates are provided with respective lips 226,228 providing an opening front edge. The upper and lower lips 226,228 are spaced apart centrally by a distance corresponding to the width of the front face 204 of the housing 202, allowing the connector assembly 200 to easily slide onto respective connection brackets 150 from adjacent batteries (separated by the housing front face 204). More specifically, the upper plate is provided with two upwardly extending upper lips 226, and the lower plate is provided with a two downwardly extending lower lips 228. The upper lips 226 and the lower lips 228 extend in a direction away from one another, creating an easily accessible gap between the biasingly engaged upper and lower plates. Furthermore, the embodiment illustrated in FIGS. 6A-6H comprises a tongue member 222 formed from a lateral mid portion of the upper plate and extending towards past the lower plate through an aperture of the lower plate. The resilient tongue member 222 is configured to retainingly engage with an respective recess or depression 214 of the housing 202. In particular, the distal end portion of the tongue member 222 is bent into a ‘foot’ adapted to align with the recess 214 during assembly. Also, during use (when coupled to the connection brackets 150), the resilient tongue member 222 is pushed out of the recess 214 thus adding to the biased contact engagement of the upper plate onto the connection bracket 150. When removed from the connection bracket 150 (e.g. during transport of the connector assembly 200), the tongue member 222 is retainingly engaged with the recess 214 of the housing 202, thus preventing the contact member 220 to accidentally slide out of engagement with the housing 202.

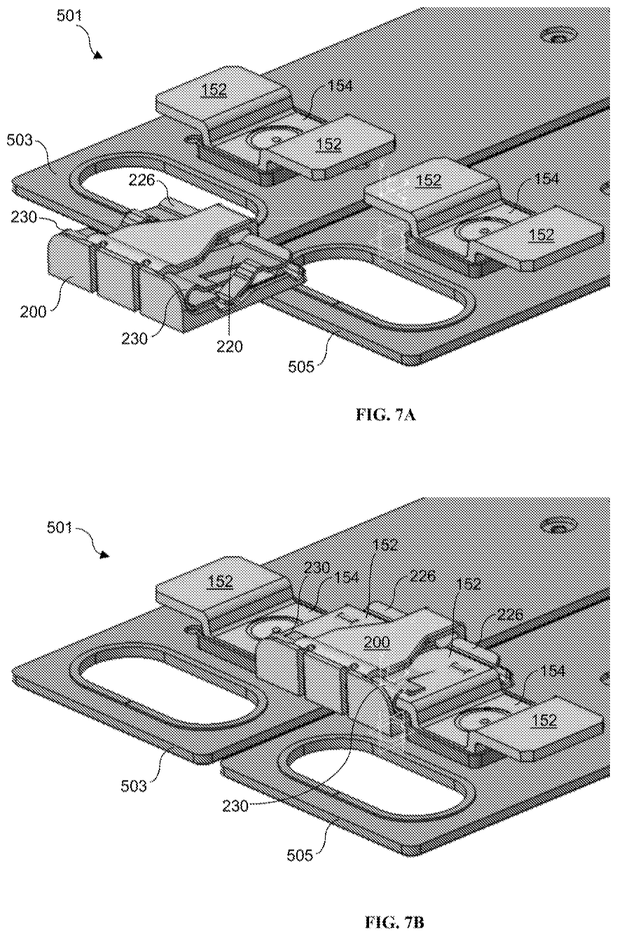

FIGS. 7A-7B shows a battery connector assembly 501, including the connection bracket assembly 160 of FIG. 4B and the battery connector 200 of FIGS. 6A-6H. In contrast to the arrangement shown in FIGS. 5A-5B, where the contact plate 120 is a substantially planar single plate that cooperates with the top face 106 of the housing to retainingly (biased) and operably engage with the connection brackets 150 on a single side, here, the battery connector 200 contacts (i.e. clamps onto) the connection brackets 150 on both, the top and bottom faces of the wings 152. During assembly, the lips 226,228 are pushed onto the wings 152 of the connection brackets 150 so as to urge the upper and lower plates of the contact plate 220 apart (i.e. away from one another) to allow the U-shaped contact plate 202 (i.e. a clip) to slide onto respective wings 152. The bias provided by the upper and lower plates (as well as the now upward deflected tongue member 222) provides a friction fit between connection brackets 150 and the connector assembly 200, creating an electrically conductive pathway between adjacent battery units.

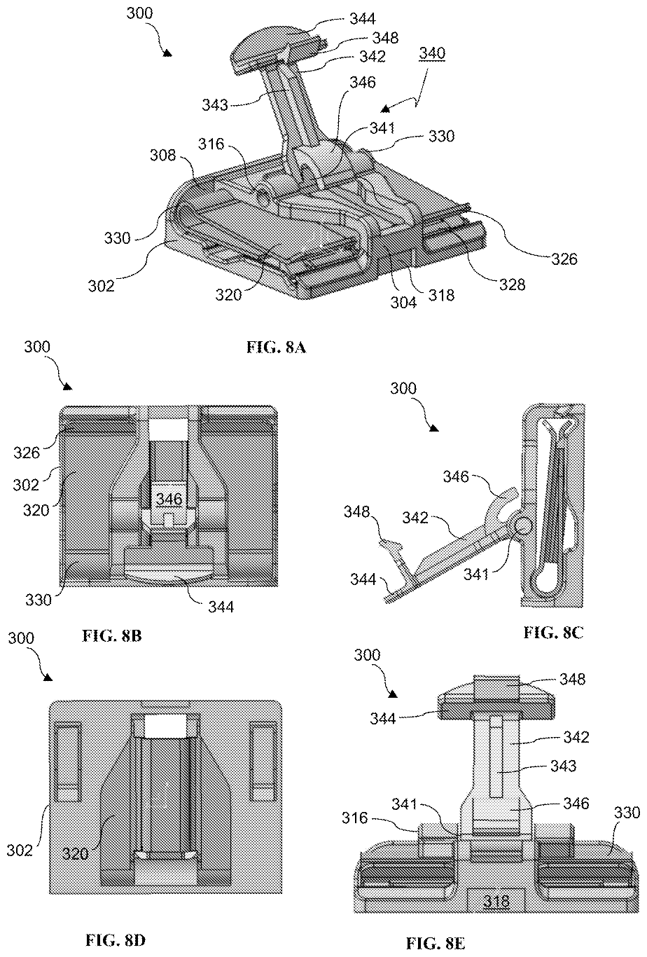

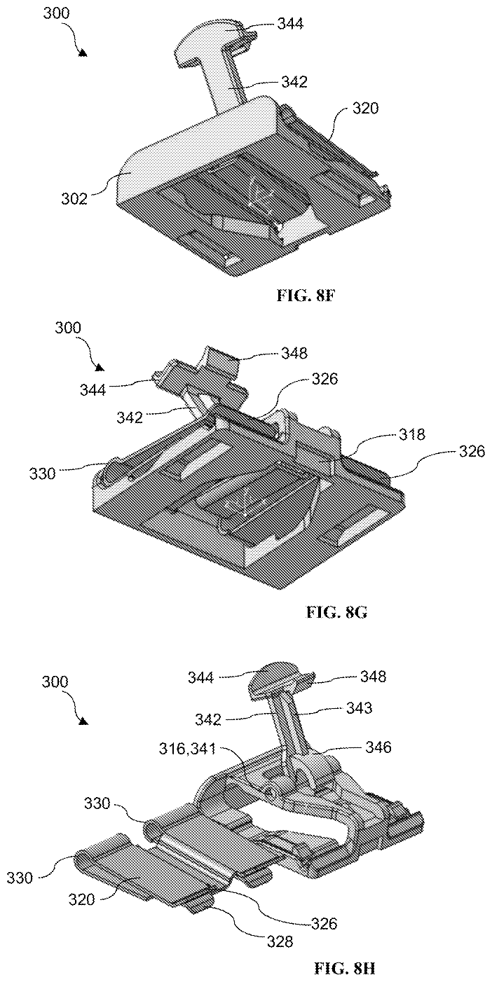

FIGS. 8A-8H shows yet a further example embodiment of a battery connector 300. The battery connector 300 of FIGS. 8A-8H is substantially the same as the battery connector 200 but further comprises a cam lever lock 340 configured to ‘lock’ the connector 300 onto respective connection brackets 150 (i.e. interface members between the battery terminals or busbars and the connector assemblies 100, 200, 300, 400). More specifically, the top face of the housing 302 comprises a central longitudinal aperture that is further provided with an axial bore 316, into which a lever arm 342 is received via pin 341. A distal end of the lever arm 342 is provided with a resilient latch member 348 (e.g. a hook, integrally formed with the lever arm 342). A strengthening rib 343 is integrally formed with the lever arm 342. An arcuate cam member 346 is provided at the proximal end (i.e. towards the pin 341) having a cam surface adapted to apply and increase the pressure onto the contact plate 320 when rotating the lever arm 342 from its open position towards its closed position. Also, the front face 304 of the housing 302 is provided with a recess (or catch) 318 configured to hookingly engage with the resilient latch member 348 when the lever arm 342 is in the closed position. Thus, the cam lever lock 340 can be used to ‘lock’ the connector plate 320 into engagement with the housing 302 (preassembly during transport) preventing the connector plate 320 from accidentally sliding out of the housing 302, as well as, to ‘lock’ the connector assembly 300 onto respective interface brackets 150.

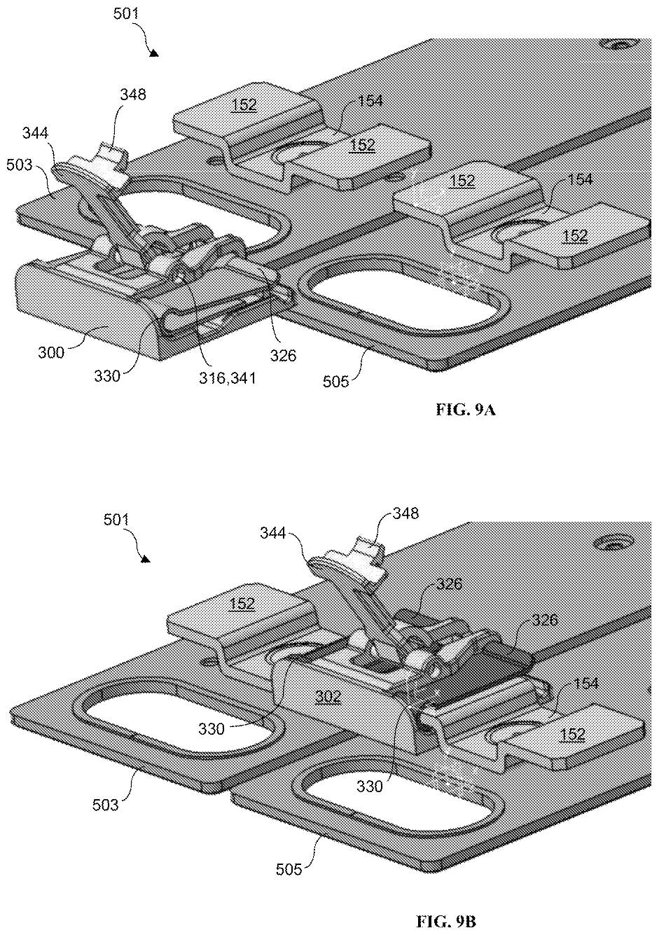

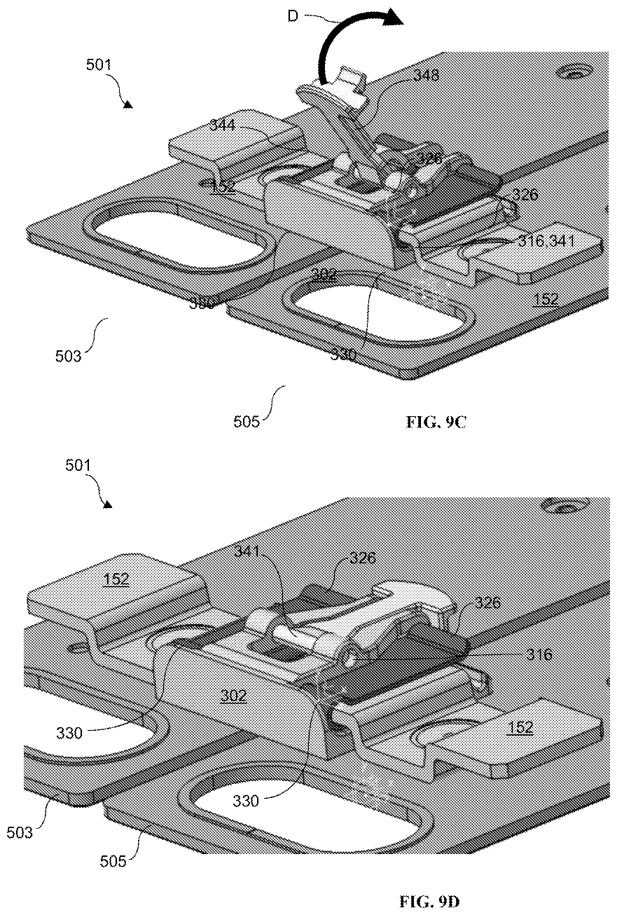

Referring now to FIGS. 9A-9D, there is shown a battery connector assembly 501, including the connection bracket assembly 160 of FIG. 4B and the battery connector 300 of FIGS. 8A-8H. Like the battery connector 200 shown in the assembly of FIGS. 7A-7B, the battery connector 300 contacts the connection brackets 150 on both the top and bottom faces of the wings 152. However, in addition, after the battery connector 300 is positioned to engage the contact plate 320 with the connection brackets 150 as shown in FIG. 9B, the lever arm 342 is pivoted about the axis of the pin 341 in the direction denoted D (see FIG. 9C), into its closed position (see FIG. 9D). The cam surface 346 urges the top surface of the contact plate 320 towards the bottom surface of the contact plate 320, thus, increasing the contact pressure between the upper and lower plate of the contact plate 320, as well as, the wings 152 positioned therebetween. In the closed position, the latch 348 engages with the recess 318 of the housing 302 to hold and lock the lever 344 into place.

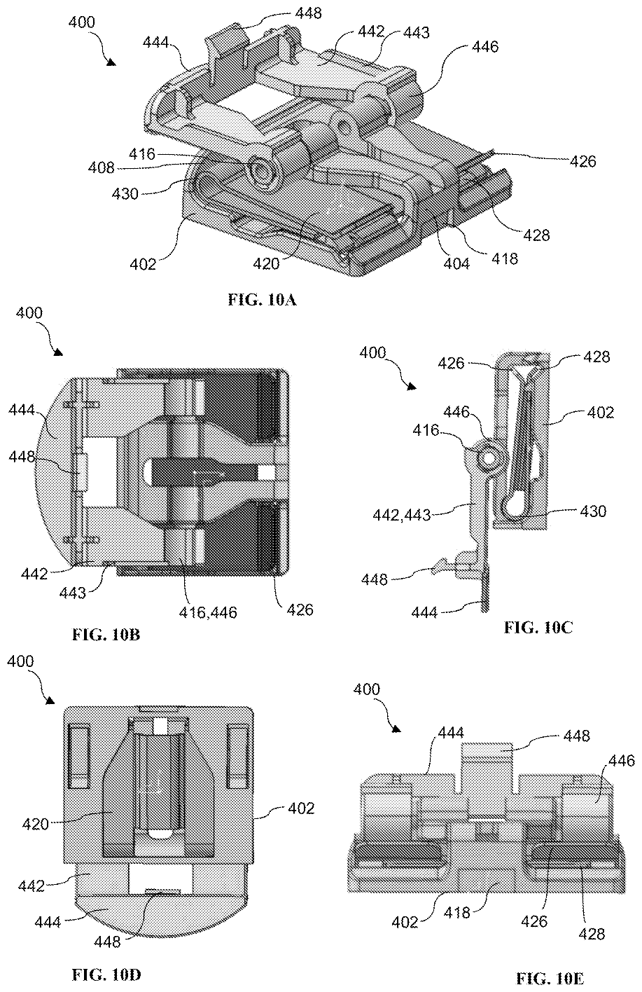

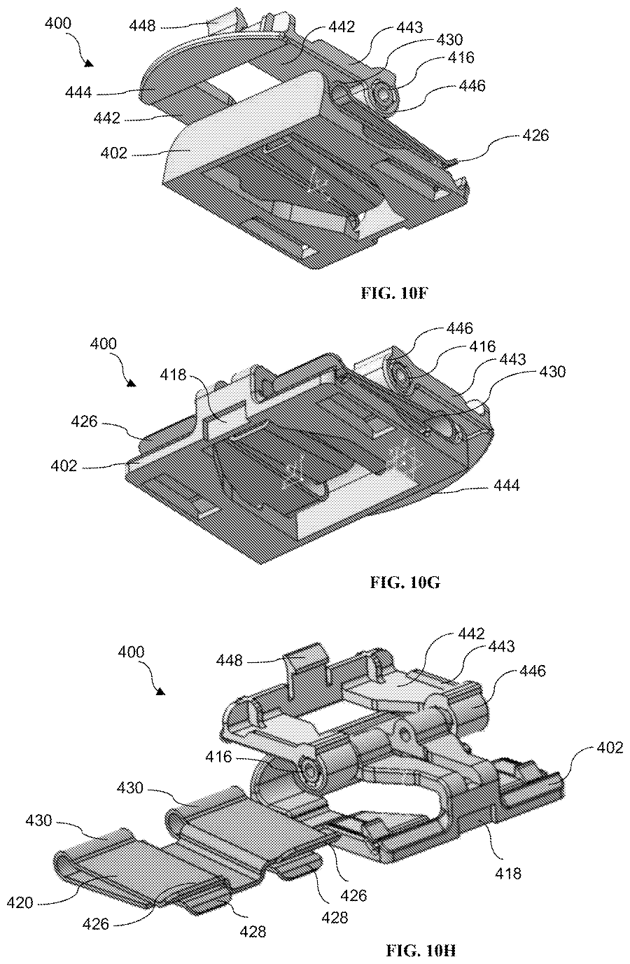

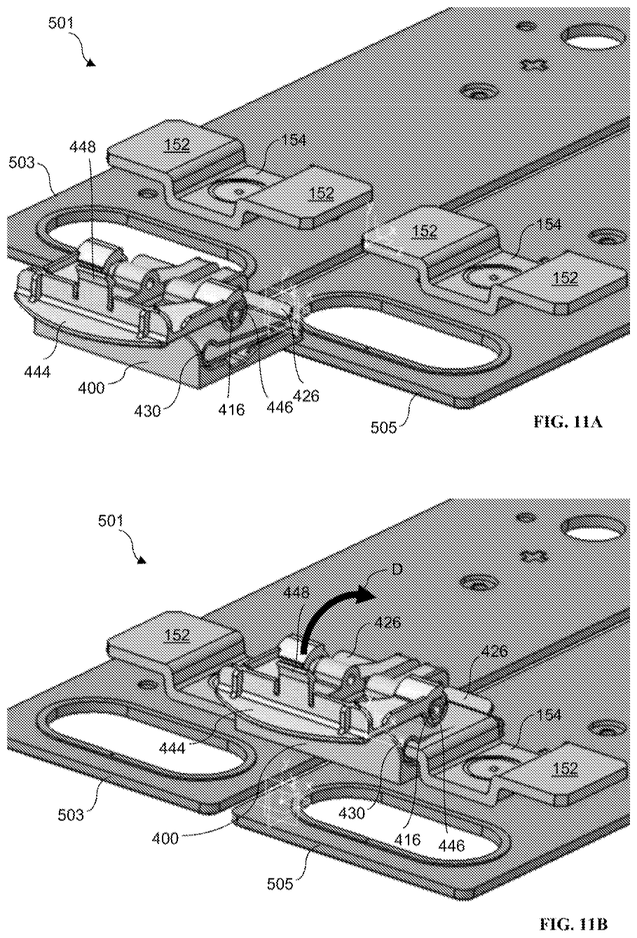

FIGS. 10A-10H shows yet another alternative example embodiment of a battery connector 400. This battery connector 400 is substantially the same as the battery connector 300 (see FIGS. 8A-8H). However, the battery connector 400 comprises a double cam lever lock 444 having two parallelly arranged conjoined lever arms 442 and cam surfaces 446, i.e. one for each of the separate upper plates. Each lever arm 442 is provided with a strengthening rib 443. In addition, instead of a pin to be inserted into the bore of a housing, the housing 402 is provided with a tubular support 416 forming a pivot point for the lever arms 442. Each lever arm 442 of the battery connector 400 is integrally formed with a cylindrical tube part 446 that encapsulates the tubular support 416. The cam members are integrally formed with the cylindrical tube parts 446 each adapted to apply contact pressure onto the contact plate 420 when moving the lever arms 442 from an open position to a closed position. This arrangement provides for a stronger contact pressure and thus a stronger coupling between the wings 152 of the interface brackets 150 and the contact plate 420 of the connector assembly 400.

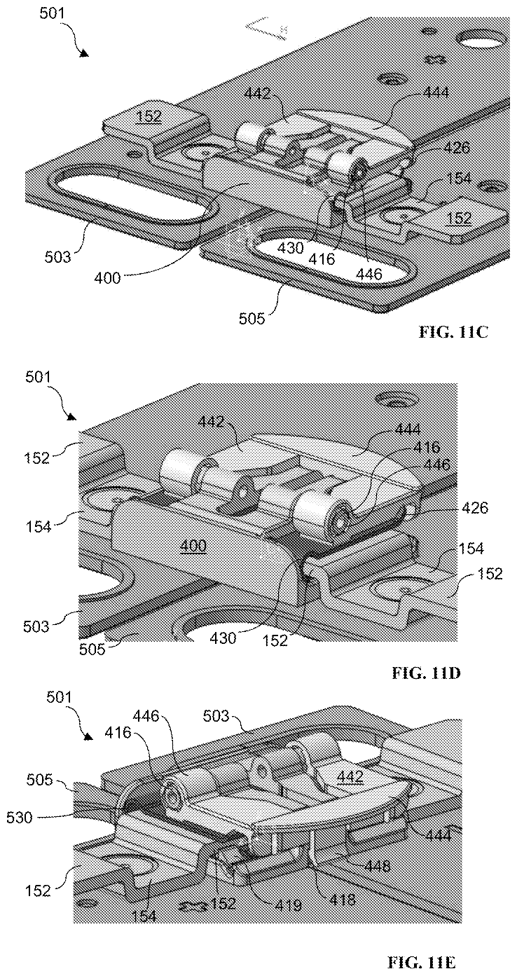

Referring now to FIGS. 11A-11E, there is shown a battery connector assembly 501, including the connection bracket assembly 160 of FIG. 4B and the battery connector 400 of FIGS. 10A-10H. Like the battery connector 300 in the assembly of FIGS. 9A-9D, after the battery connector 400 is positioned to engage the contact plate 420 with the connection brackets 150 as shown in FIG. 11B, the lever arm 442 is pivoted about its pivot axis into its closed position (see FIG. 11C). As best seen in FIG. 11E, the housing 402 of embodiment 400 (but also the housing 202 and 302 of the other embodiments 200 and 300) include two spaced apart stop members 419 configured allow the connector to slide onto the wings 152 (i.e. via forwardly inclined front surface), but prevent the wings 152 to slide out of engagement with the connector plate 420 (i.e. due to vertical rear surface), i.e. the stop members 419 are shaped like a saw tooth. Also, similar to the arrangement described with reference to FIGS. 9A-9D, a latch 448 is provided to lockingly engage with the respective recess 418 on the housing 402.

It will be appreciated by persons skilled in the art that the above detailed examples have been described by way of example only and not in any limitative sense, and that various alterations and modifications are possible without departing from the scope of the invention as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

### COMPONENT LIST AND REFERENCE NUMERALS

1 Battery module
3 Battery
5 Positive temperature coefficient (PTC) thermistor
7 Connection member
9 Connector
11 Connection terminal
13 Insulating member
51 Battery pack system
53 Battery
57 Busbar
59 Electric connector
65 Case
100,200,300,400 Battery connector assembly
102,202,302,402 Housing
104,204,304,404 Front face
106,206 Top face
108,208,308,408 Rear face
110 Protruding pin
112 Hook
114,214 Cavity
120,220,320,420 Contact plate
122,222 Legs
124,224 Foot
150 Connection bracket
152 Wing
154 Base
160 Bracket assembly
162 Coupling
226,326,426 Upper lip
228,328,428 Lower lip
230,330,430 Fold
316,416 Bore
318,418 Recessed surface
340 cam lever lock
341 Pin
342,442 Lever arm
343,443 Strengthening rib
344,444 Lever
346 Arcuate part
348,448 Latch
419 Stop
446 Cylindrical tube part
501 Battery connector assembly
503 First terminal
505 Second terminal

1. A battery connector assembly for mechanically and electrically coupling two or more batteries, comprising:
at least two interface members, each interface member configured to connect to respective terminals of two adjacent batteries:
an electrical contact member, configured to operably attach to said at least two interface members so as to provide an electrically conductive conduit between the two adjacent batteries; and
a connector housing, comprising a slot adapted to retainingly receive and cooperate with said electrical contact member.

2. A battery connector assembly according to claim 1, wherein at least a portion of said electrical contact member is adapted to biasingly engage with said at least two interface members of the two adjacent batteries.

3. A battery connector assembly according to claim 1, wherein said electrical contact member comprises an upper contact plate and an opposing lower contact plate.

4. A battery connector assembly according to claim 3, wherein said electrical contact member comprises a fold conjoining said upper contact plate and said lower contact plate so as to form a resiliently biased U-shaped clip.

5. A battery connector assembly according to claim 4, wherein said electrical contact member further comprises at least one retainer member configured to operably engage with said housing so as to retain said electrical contact member within said housing.

6. A battery connector assembly according to claim 1, further comprising a cam lever lock mechanism operably coupled with said connector housing and adapted to contactingly and retainingly engage with said electrical contact member.

7. A battery connector assembly according to claim 5, further comprising a latch mechanism adapted to lockingly engage a lever arm of said lever lock mechanism with said connector housing when in a closed position.

8. A battery connector assembly according to claim 1, wherein said electrical contact member is made of an electrically conductive material.

9. A battery connector assembly according to claim 1, wherein said connector housing is made of an electrically insulating material.

10. An electric vehicle battery array, comprising a plurality of electric vehicle battery modules operably connected by one or more of said battery connector assembly according to claim 1.
